(19) United States
(12) Patent Application Publication
(10) Pub. No.: US 2021/0166180 A1
(43) Pub. Date: Jun. 3, 2021

(54) INFORMATION PROCESSING APPARATUS, INFORMATION PROCESSING METHOD, AND WORK EVALUATION SYSTEM

(71) Applicant: Sony Corporation, Tokyo (JP)

(72) Inventor: Hideyuki MATSUNAGA, Tokyo (JP)

(73) Assignee: Sony Corporation, Tokyo (JP)

(21) Appl. No.: 17/047,693

(22) PCT Filed: Aug. 23, 2018
(86) PCT No.: PCT/JP2018/031188

§ 371 Date: Oct. 15, 2020

(51) Int. Cl. G06Q 10/06; G06T 7/00; G06K 9/00; G06T 7/70; G06Q 50/04

(52) U.S. Cl. CPC G06Q 10/06393; G06T 7/0004; G06K 9/00335; G06T 7/70; G06Q 10/1093; G06Q 50/04; G06T 2207/10016; G06T 2207/30196; G06T 2207/30232; G06Q 10/063114

(57) ABSTRACT

To provide an information processing apparatus capable of quantitatively evaluating a work status of a worker.

The information processing apparatus includes: a work identification unit that identifies a work content and a working hour of a worker based on time-series data of position information of the worker at least in a work region; and a quantified information generation unit that generates quantified information quantitatively expressing a work status of the worker, based on time-series data of a production amount on a work line corresponding to the identified work content, and the working hour of the worker.

### FIELD

The present disclosure relates to an information processing apparatus, an information processing method, and a work evaluation system.

### BACKGROUND

Quantitative evaluation is useful to make people have a common perception about an issue. However, it is difficult to perform quantitative evaluation on some evaluation targets. For example, factories are often operated based on the experience of workers, and a work status such as a performance of a worker is not quantitatively expressed and evaluated.

For example, Patent Literature 1 discloses a factory diagnostic device that performs evaluation of a factory by using a quantitative evaluation item that quantitatively expresses the evaluation of the factory, and a qualitative evaluation item that qualitatively expresses the evaluation of the factory, and determines a countermeasure for issues of the factory to be addressed, based on an evaluation result.

### CITATION LIST

### Patent Literature

Patent Literature 1: Japanese Laid-open Patent Publication No. 2004-102325

### SUMMARY

### Technical Problem

However, although work automation in factories is under progress, there are still many manual works, and it is difficult to accurately obtain work statuses of the manual works. In order to improve productivity in factories, it is important to be able to correctly evaluate a work status such as a performance of a worker.

Therefore, the present disclosure proposes a novel and improved information processing apparatus, information processing method, and work evaluation system capable of quantitatively evaluating a work status of a worker.

### Solution to Problem

According to the application concerned, an information processing apparatus is provided that includes:

a work identification unit that identifies a work content and a working hour of a worker based on time-series data of position information of the worker at least in a work region; and a quantified information generation unit that generates quantified information quantitatively expressing a work status of the worker, based on time-series data of a production amount on a work line corresponding to the identified work content, and the working hour of the worker.

Moreover, according to the application concerned, an information processing method is provided that includes:

identifying a work content and a working hour of a worker based on time-series data of position information of the worker at least in a work region; and generating quantified information quantitatively expressing a work status of the worker, based on time-series data of a production amount on a work line corresponding to the identified work content, and the working hour of the worker.

Furthermore, according to the application concerned, a work evaluation system is provided that includes: a position information acquisition device that acquires position information of a worker in at least a work region as time-series data; a production amount acquisition device that acquires a production amount on a work line in the work region as time-series data; and an information processing apparatus including a work identification unit that identifies a work content and a working hour of the worker based on the time-series data of the position information of the worker in the work region, and a quantified information generation unit that generates quantified information quantitatively expressing a work status of the worker, based on the time-series data of the production amount on the work line corresponding to the identified work content, and the working hour of the worker.

### Advantageous Effects of Invention

As described above, according to the present disclosure, it is possible to quantitatively evaluate a work status of a worker. Note that the above effects are not necessarily limited, and in addition to or in place of the above effects, any of the effects described in the present specification, or other effects that can be grasped from the present specification may be obtained.

### BRIEF DESCRIPTION OF DRAWINGS

FIG. 1 is a diagram for describing application to work evaluation in a factory, as an application example of a work evaluation system according to an embodiment of the present disclosure.

FIG. 2 is a system configuration diagram illustrating the work evaluation system according to the embodiment.

FIG. 3 is a functional block diagram illustrating a functional configuration of an information processing apparatus of the work evaluation system according to the embodiment, and illustrates functional units that perform work quantification processing.

FIG. 4 is a flowchart illustrating an example of the work quantification processing performed by the information processing apparatus according to the embodiment.

FIG. 5 is a diagram illustrating movement trajectories of workers A and B in a work region for one day.

FIG. 6 is a diagram illustrating a relationship between setting of an object in the work region performed by a user and a working hour of a worker.

FIG. 7 is a diagram illustrating an example of work result information.

FIG. 8 is a diagram illustrating an example of quantified information.

FIG. 9 is a functional block diagram illustrating a functional configuration of the information processing apparatus of the work evaluation system according to the embodiment, and illustrates functional units that perform work prediction processing.

FIG. 10 is a diagram illustrating an example of performance feature amount data.

FIG. 11 is a diagram illustrating an example of production amount data.

FIG. 12 is a diagram illustrating an example of personal feature amount data.

FIG. 13 is a flowchart illustrating the work prediction processing performed by the information processing apparatus according to the embodiment.

FIG. 14 is a diagram illustrating an example of presentation of a result of optimization of job rotation.

FIG. 15 is a diagram illustrating an example of presentation of a mutual relationship between workers.

FIG. 16 is a functional block diagram illustrating a functional configuration of the information processing apparatus of the work evaluation system according to the embodiment, and illustrates functional units that perform real-time processing.

FIG. 17 is a flowchart illustrating the real-time processing performed by the information processing apparatus according to the embodiment.

FIG. 18 is a block diagram illustrating a hardware configuration example of the information processing apparatus according to the embodiment.

### DESCRIPTION OF EMBODIMENTS

Hereinafter, preferred embodiments of the present disclosure will be described in detail with reference to the accompanying drawings. Note that, in the present specification and the drawings, constituent elements having substantially the same functional configuration are designated by the same reference numerals, and an overlapping description is omitted.

Note that the description will be given in the following order.
1. Overview of Work Evaluation System
2. System Configuration
(1) Work Region
(2) Information Processing Apparatus
3. System Functions
3.1. Work Quantification Processing
(1) Functional Configuration
(2) Processing Example
(3) Utilization of Quantified Information
3.2. Work Prediction Processing
(1) Functional Configuration
(2) Processing Example
3.3. Real-time Processing
(1) Functional Configuration
(2) Processing Example
4. Hardware Configuration

### 1. Overview of Work Evaluation System

First, an overview of a work evaluation system according to an embodiment of the present disclosure will be described. The work evaluation system according to the present embodiment is a system for quantitatively evaluating a work status of a worker based on time-series data such as movement and motion of the worker. Hereinafter, as an application example of the work evaluation system according to the present embodiment, a case where the work evaluation system is applied to evaluate a work status of a worker in a work line of a factory will be described. Note that the work evaluation system according to the present disclosure can be applied to other than work evaluation of workers in factories, and can also perform work evaluation of workers at various work sites such as farms. Further, in the work evaluation system according to the present disclosure, it is possible to regard a gym or the like as a work site and evaluate, as the work status, a training status of a user at the gym.

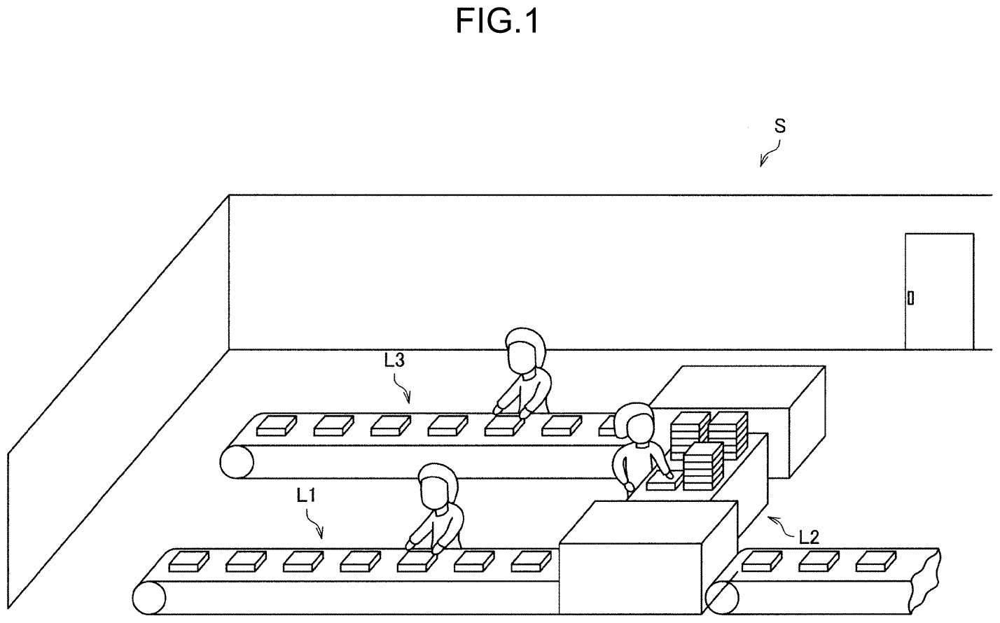

For example, as illustrated in FIG. 1, it is assumed that a plurality of work lines L1 to L3 are arranged in a work region S in a factory. Workers currently work on the work lines L1 to L3, respectively. Such work on the work lines L1 to L3 of the factory is often performed at fixed positions. Therefore, in the work evaluation system according to the present embodiment, a work content of a worker is identified based on a work position of the worker by acquiring position information of the worker in the work region S. Further, in a case where at least the position information of the worker in the work region S is acquired as time-series data, it is possible to identify where the worker currently stays in the work region S and to where the worker moved. Furthermore, the work content of the worker may be identified by using motion information of a body part of the worker, such as a hand motion, a finger motion, or a body motion.

On the other hand, it can be considered to use work result information as an index indicating a performance of a worker. Examples of the work result information include the number of products (that is, a production amount) processed in the work lines L1 to L3, a quality of a processed product, and the like. Such work result information of the work lines L1 to L3 can be acquired by, for example, capturing an image of a product conveyed on the line with an image capturing device, and the like.

The work evaluation system according to the present embodiment can evaluate work of a worker by associating identification of a work status based at least on position information of the worker with identified work result information of a work line on which the worker works. Thereby, for example, it becomes possible to show work efficiency of the worker and a work quality.

Further, in the work evaluation system according to the present embodiment, when a plurality of workers work together, a prediction model that predicts productivity in the entire factory that results from a change in personnel arrangement, based on a result of evaluating work of each worker can be built. For example, as illustrated in FIG. 1, when the plurality of work lines L1 to L3 are arranged in the work region S of the factory, in a case where the worker working on each of the work lines L1 to L3 is fixed, it can be considered that the worker does not correctly understand a work content other than work that he/she is responsible for. In order to improve the productivity in the entire factory, it is desirable that each worker is a multi-skilled worker and correctly understands work contents performed on each of the work lines L1 to L3. In the work evaluation system, it is possible to build a prediction model that predicts a relationship between productivity and workers on the work lines L1 to L3, and to predict appropriate job rotation for increasing productivity of a worker.

Furthermore, even for the same work content, productivity may differ for each worker. A worker who can work efficiently has the know-how to work efficiently based on experiences. It is desirable that such know-how is shared among workers, but it is not easy to analyze what the know-how is. Further, in some cases, the worker works unconsciously, and thus the worker himself/herself does not recognize what he or she is doing to improve work efficiency. The work evaluation system according to the present embodiment can also provide a comparison tool that can easily compare work states of the respective workers by using videos. With this, for example, a video of a worker who can work efficiently and a video of another worker can be compared using the comparison tool, and the know-how or tips for an efficient work can be obtained from a difference between the work of the workers.

In addition, the work evaluation system can also associate a work content that can be identified based on position information of a worker with a work result in real time. A result of the real-time processing can be used, for example, to check whether or not the worker is correctly performing a determined routine work, or to confirm that the worker can perform the work safely.

Hereinafter, a configuration of the work evaluation system according to the present embodiment and processing that can be performed by the work evaluation system will be described in detail.

### 2. System Configuration

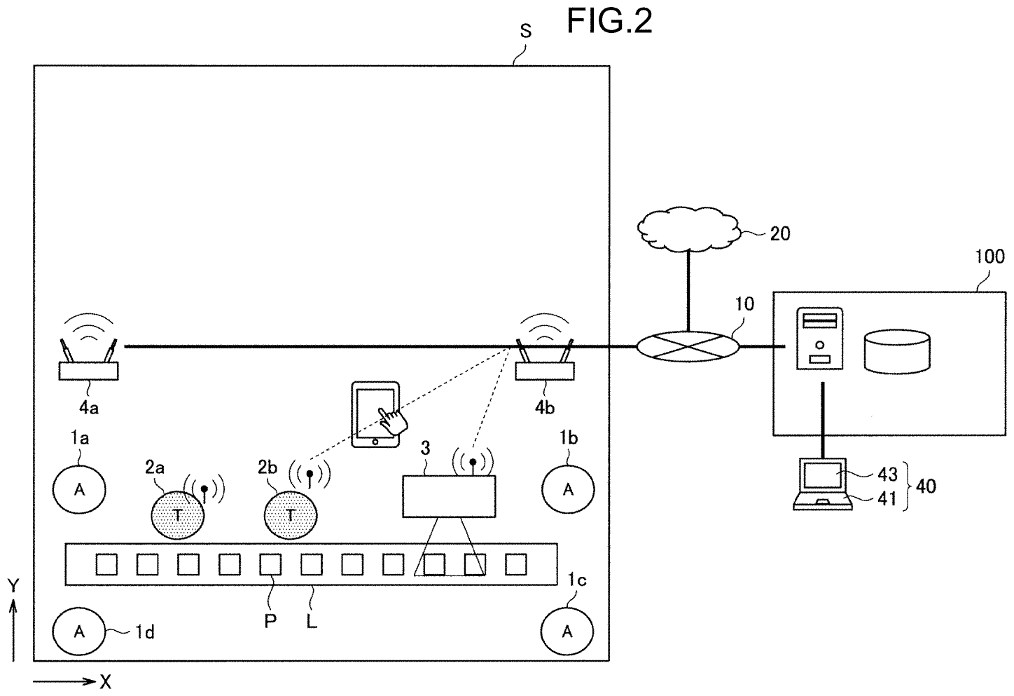

A system configuration of a work evaluation system 1 according to the present embodiment will be described with reference to FIG. 2. FIG. 2 is a system configuration diagram illustrating the work evaluation system 1 according to the present embodiment.

As illustrated in FIG. 2, the work evaluation system 1 according to the present embodiment acquires position information of a worker and work result information in a work region S. The acquired information is output to an information processing apparatus 100 via a network 10, and analyzed.

### (1) Work Region

The position information of the worker in the work region S can be obtained, for example, by using a plurality of anchors 1a to 1d installed in the work region S, and a tag 2a or 2b held by the worker as illustrated in FIG. 2.

The anchors 1a to 1d are devices provided with position information of installation positions in the work region S. For example, when the work region S is viewed in a plan view in an X-Y plane, the anchors 1a to 1d can be provided with position information indicating installation positions of the anchors 1a to 1d using XY coordinates.

The tags 2a and 2b are wireless communication devices held by workers in order to acquire position information of the workers in the work region S. A worker holds one tag. FIG. 2 illustrates that a worker holding the tag 2a and a worker holding the tag 2b are in the work region S. The tags 2a and 2b acquire the position information (XY coordinates) of the anchors 1a to 1d in advance, and identify the positions of the tags 2a and 2b in the work region S by measuring distances from the anchors 1a to 1d. The tags 2a and 2b output the identified positions in the work region S as position information of the workers on a predetermined cycle through wireless communication and are output to the information processing apparatus 100 via the network 10.

In the work region S, for example, an image capturing device 3 may be arranged as a device for acquiring the work result information. For example, in the example illustrated in FIG. 2, the image capturing device 3 continuously captures an image of a product P manufactured on the work line L and conveyed on the line. The work result information such as the number of products P (production amount) manufactured in the work line L, and a quality of the product P can be acquired from a video acquired by the image capturing device 3. The video acquired by the image capturing device 3 is output to the information processing apparatus 100 via the network 10.

Note that a motion information acquisition device (not illustrated) for acquiring motion information of a body part of a worker, such as a hand motion, a finger motion, or a body motion, may be additionally arranged in the work region S. A work content of a worker can also be identified based on the motion information of the body part.

The motion information acquisition device is, for example, an image capturing device that is fixedly installed at a position at which an image of a worker who works at a predetermined work position on the work line L can be captured, and continuously captures an image of a worker who works at a work position. Thereby, motion information of a body part of a worker who is working, such as a hand motion, a finger motion, or a body motion, can be acquired. Alternatively, the motion information of the body part of the worker may be information based on a measurement value of a sensor that can detect the movement or posture of the body part, such as an acceleration sensor. Further, information acquired by spatial scanning such as LiDAR may be used as the motion information of the body part of the worker. The motion information of the body part of the worker that is acquired by the motion information acquisition device is output to the information processing apparatus 100 via the network 10, similarly to the video acquired by the image capturing device 3.

For the wireless communication in the work region S, for example, Wi-Fi and the like may be used. In this case, the tags 2a and 2b and the image capturing device 3 are equipped with a wireless local area network (LAN), and information output from the tags 2a and 2b and the image capturing device 3 is output from routers 4a and 4b to the information processing apparatus 100 via the network 10. The information output from the routers 4a and 4b may be output to a cloud 20.

### (2) Information Processing Apparatus

The information processing apparatus 100 performs processing of evaluating work of a worker in the work region S based on information acquired in the work region S. The information processing apparatus 100 is connected to an interface terminal 40 including an input unit 41 and an output unit 43. The information processing apparatus 100 can perform processing based on information input by an operator or the like through the input unit 41. Further, the information processing apparatus 100 can output a processing result and the like to the output unit 43. Note that the input unit 41 and the output unit 43 may be provided as different devices. A detailed functional configuration of the information processing apparatus 100 will be described later.

Hereinabove, an example of the system configuration of the work evaluation system 1 according to the present embodiment has been described.

### 3. System Functions

Functions of the work evaluation system 1 will be described in detail. The processing performed by the work evaluation system 1 is roughly classified into work quantification processing of quantifying work of a worker based on accumulated data, work prediction processing for improving productivity, and real-time processing of checking a work status of a worker in real time. Hereinafter, these processing will be described in detail.

### 3.1. Work Quantification Processing

### (1) Functional Configuration

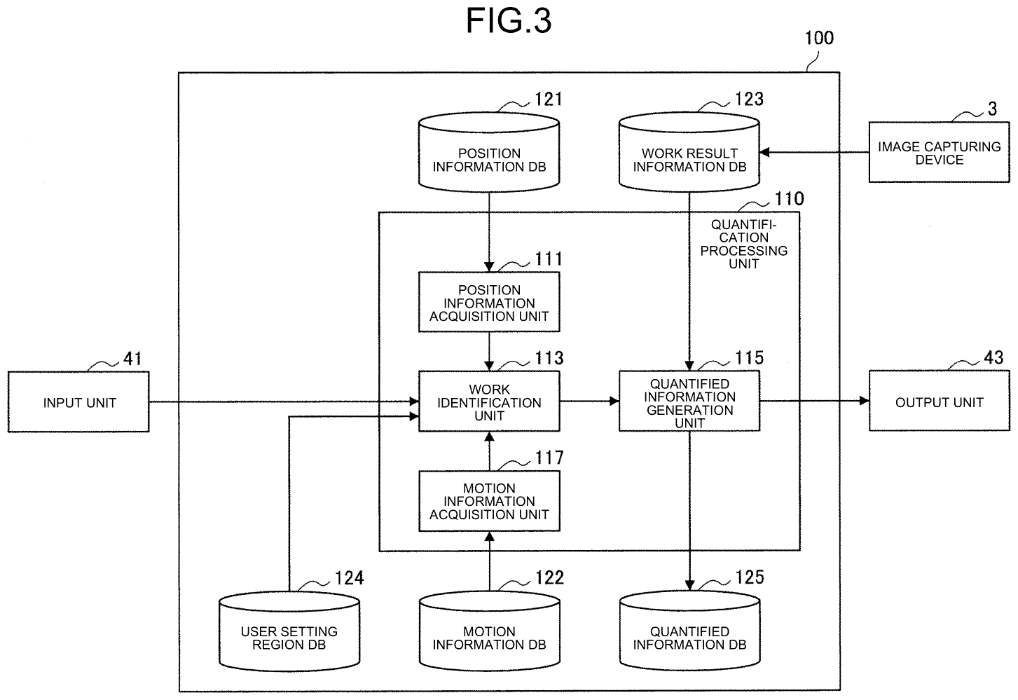

First, a configuration of functional units of the information processing apparatus 100 that are operated when performing the work quantification processing will be described with reference to FIG. 3. FIG. 3 is a functional block diagram illustrating a functional configuration of the information processing apparatus 100 of the work evaluation system 1 according to the present embodiment, and illustrates the functional units that perform the work quantification processing.

As illustrated in FIG. 3, the information processing apparatus 100 includes, as the functional units that perform the work quantification processing, a quantification processing unit 110, and databases such as a position information database (DB) 121, a motion information DB 122, a work result information DB 123, a user setting region DB 124, and a quantified information DB 125.

The quantification processing unit 110 quantitatively evaluates a work status of a worker based on at least position information of the worker in the work region S and work result information. As illustrated in FIG. 3, the quantification processing unit 110 includes a position information acquisition unit 111, a work identification unit 113, a quantified information generation unit 115, and a motion information acquisition unit 117.

The position information acquisition unit 111 acquires position information of each worker that is acquired from the tags 2a and 2b in the work region S. The position information acquisition unit 111 may acquire the time-series data of the position information of the worker for a predetermined period from the position information DB 121 in which the position information of the worker acquired from the tags 2a and 2b is accumulated. Further, in a case of analyzing a work status of a worker in real time, the position information acquisition unit 111 may directly acquire position information of the worker output from the tag 2a or 2b via the network 10. The position information acquisition unit 111 outputs the acquired position information of the worker to the work identification unit 113.

The work identification unit 113 identifies a work content of a worker based on at least position information of the worker in the work region S. In a factory work line or the like, a position where a worker works is often fixed. Therefore, the work identification unit 113 identifies a work content of a worker according to, for example, position information of a work area in the work region S, based on position information of the worker. Information other than the position information of the work area may be used to identify the work content. Alternatively, the work content of the worker may be identified based on position information of an object highly related to the work content. The object in the work region S may be a facility arranged in the work region S, or may be a physical object or virtual object such as a gate or region that the worker passes when performing a specific work. Further, the object in the work region S may be set in advance, or may be set based on an object setting instruction input by the user through the input unit 41.

Details of work identification processing performed by the work identification unit 113 will be described later. The work identification unit 113 outputs, to the quantified information generation unit 115, an identified work content of the worker in association with time information represented by a working hour or working time.

The quantified information generation unit 115 quantifies a work status of a worker based on position information of the worker and work result information. Examples of the work result information include the number of products (that is, a production amount) processed in a work line, a quality of a processed product, and the like, each of which are associated with the time information. The work result information is acquired in the work region S by the image capturing device 3 or the like and recorded in the work result information DB. The quantified information generation unit 115 generates quantified information in which a work status of a worker is quantitatively expressed by work result information by associating, based on time information, a work content identified based on position information of the worker with work result information related to the work content. For example, a relationship between a working hour of the worker and the number of products processed by work of the worker, and the like can be shown by using such quantified information. The quantified information generation unit 115 may record the generated quantified information in the quantified information DB, or may perform processing of outputting the quantified information to the output unit 43 to present the quantified information to an operator or the like.

The motion information acquisition unit 117 acquires motion information of a body part of a worker acquired in the work region S. The motion information acquisition unit 117 acquires motion information from the motion information DB 122 that stores, as motion information, for example, a video acquired by continuously capturing an image of a worker who works at a predetermined work position on the work line L. In a case of analyzing a work status of a worker in real time, the motion information acquisition unit 117 may directly acquire a video output from the motion information acquisition device installed on the work line L via the network 10. The motion information acquisition unit 117 outputs the acquired motion information of the body part of the worker to the work identification unit 113.

Note that the motion information acquisition unit 117 may be operated only in a case where motion information of a body part of a worker can be acquired. It is possible to estimate what kind of work is being performed from a hand motion, a finger motion, or a body motion of the worker who is working. Therefore, a work content may be identified by, for example, acquiring, as a sample, a motion of a body part of a worker that corresponds to the work content in advance, and identifying, by the work identification unit 113, a sample that matches motion information of the body part of the worker acquired by the motion information acquisition device.

### (2) Processing Example

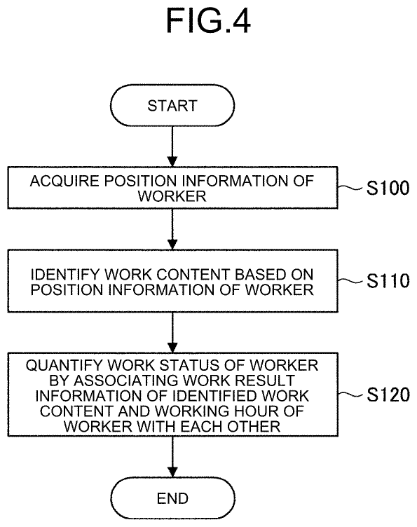

The work quantification processing performed by the information processing apparatus 100 will be described with reference to FIG. 4. FIG. 4 is a flowchart illustrating an example of the work quantification processing performed by the information processing apparatus 100.

### Acquisition of Position Information

First, the position information acquisition unit 111 of the information processing apparatus 100 acquires position information of each worker acquired in the work region S (S100). The position information of each worker can be acquired from each of the tags 2a and 2b held by the respective workers, as illustrated in FIG. 2, for example. Alternatively, the position information of each worker may be obtained by analyzing an image captured by a camera that captures an image of an area inside the work region S. Alternatively, the position information of each worker may be acquired by using a self-position estimation method such as simultaneous localization and mapping (SLAM). The position information acquisition unit 111 acquires position information of a worker for a predetermined period from the position information DB 121 in which position information of workers is accumulated. As the position information of the worker, at least data corresponding to a period of which a work status of the worker is to be checked may be acquired. The position information acquisition unit 111 outputs the acquired position information of the worker to the work identification unit 113.

### Identification of Work Content

Next, the work identification unit 113 identifies a work content of a worker based on position information of the worker in the work region S (S110). In a factory work line or the like, a position where a worker works is often fixed. Therefore, the work identification unit 113 identifies a work content of a worker according to position information of an object in the work region S such as a work area, based on the position information of the worker.

The position information of the object in the work region S is represented by the same coordinate system as that of the position information of the worker. The position information of the object in the work region S may be set in advance based on layout information of the work region S or the like, or may be set based on an object setting instruction input by the user through the input unit 41.

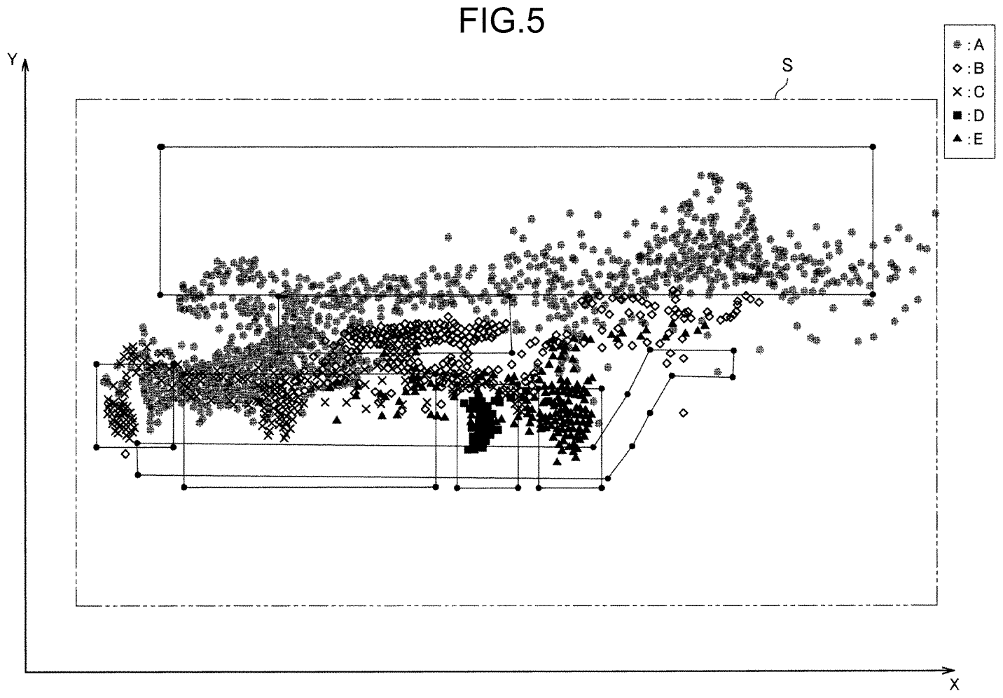

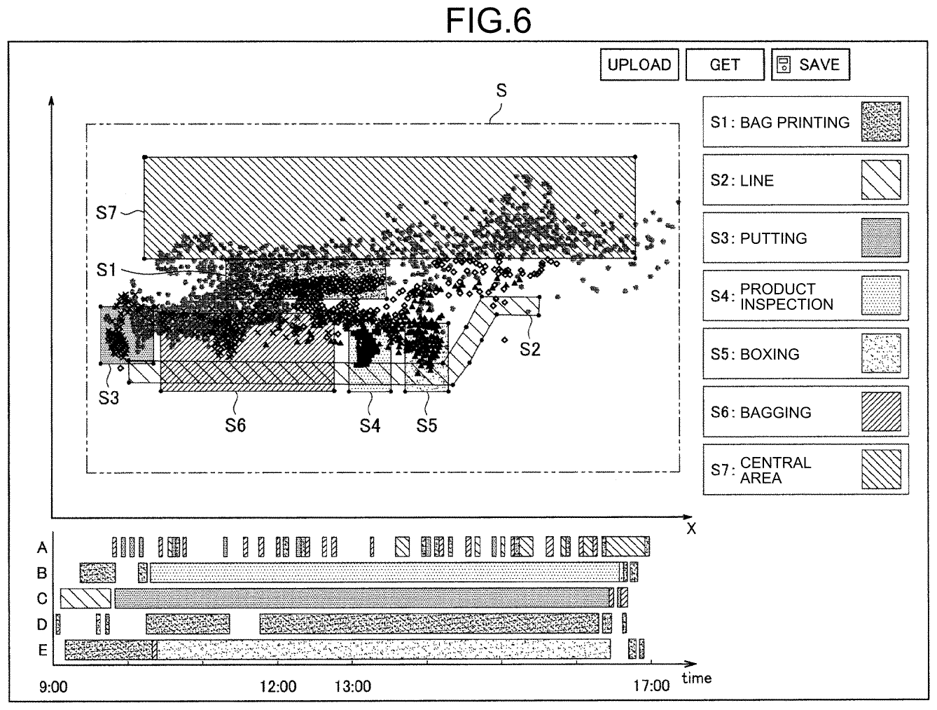

An example of setting processing in a case of setting the position information of the object in the work region S based on the object setting instruction from the user will be described with reference to FIGS. 5 and 6. FIG. 5 illustrates movement trajectories of workers A to E in the work region S for a certain period. A movement trajectory can be generated, for example, by plotting time-series data of position information of a worker acquired in Step S100, on XY coordinates indicating the work region S. Such a movement trajectory of the worker in the work region S can be presented to the user through the output unit 43. The user can specify the object in the work region S by specifying a region related to the work content of the worker in the work region S in which the movement trajectory of the worker is shown.

The setting of the object by the user can be performed by, for example, setting frames or the like indicating object regions S1 to S7 in the work region S in which the movement trajectories of the workers on the XY coordinates are shown, as illustrated on the upper side of FIG. 6. This allows the user to arbitrarily set, as the object region, a position of an object highly related to the work content, such as a work area, a facility, or a gate. In the example of FIG. 6, the object region S1 corresponds to a bag printing work area, the object region S2 corresponds to the line, and the object region S3 corresponds to a putting work area. The object region S4 corresponds to a product inspection work area, the object region S5 corresponds to a boxing work area, and the object region S6 corresponds to a bagging work area. The object region S7 corresponds to the central area of the factory.

Note that the shape of the frame indicating the object region is not particularly limited, and may be rectangular as illustrated in FIG. 6, polygonal, circular, or the like. Further, a corresponding work content may be associated with the set object region. User setting region information in which each of the object regions (S1 to S7) is associated with an object (for example, a work area, a line, or the like) that can identify a corresponding work content may be recorded in the user setting region DB 124. This allows the user to easily set a desired object region in the work region S by using the user setting region information already recorded in the user setting region DB 124. Alternatively, the work identification unit 113 may refer to the user setting region information recorded in the user setting region DB 124 to automatically set the object region in the work region S.

Once an object region is set based on the layout information or the object setting instruction, the work identification unit 113 obtains time information indicating a time for which the worker stays in the object region from a movement trajectory of the worker included in the object region. For example, in a case where the object regions S1 to S7 are set based on the movement trajectories of the workers A to E illustrated on the upper side of FIG. 6, the work identification unit 113 can present, on a time axis, a time for which each of the workers A to E stays in each of the object regions S1 to S7 as illustrated on the lower side of FIG. 6. From this, it can be seen that, for example, the worker A moves around the entire work region S from the start to the end of the work. Further, it can be seen that the worker B stays in the bag printing work area (object region S1) in a time zone close to the start and end of the work, and mainly stays in the product inspection work region (S2) at other times. In this way, the position information of the worker and the stay time information can be presented based on the movement trajectory.

Here, in a work line of a factory, or the like, since a position where a worker works is roughly fixed, the position information of the object region can be regarded as the work content. Further, a time for which the worker stays and a time at which the worker stays can be regarded as a working hour and a stay time of a work performed in the object region. Therefore, the work identification unit 113 identifies the work content corresponding to the object region based on information indicating a correspondence between the object region and the work content. The correspondence between the object region and the work content may be set in advance, or may be set by the user when setting the object region. For example, the work content such as bag printing, putting, product inspection, boxing, or bagging may be associated in advance with the layout information of the work region S, and similarly, the work content may be associated with the user setting region information recorded in the user setting region DB 124, and be recorded.

The work identification unit 113 identifies the work content of the worker according to the object region, based on the information indicating the correspondence between the object region and the work content. For example, as for the worker B, it is identified that the worker B performs product inspection work that is performed in a work area corresponding to the object region S2, based on the fact that the worker B mainly stays in the object region S2 as illustrated on the lower side of FIG. 6. The work identification unit 113 outputs, to the quantified information generation unit 115, an identified work content of the worker in association with time information represented by a working hour or working time. In other words, through the processing of Step S110, data indicating when and where each worker works is acquired.

### Generation of Quantified Information

The quantified information generation unit 115 quantifies a work status of a worker based on a work content based on position information of the worker acquired in Step S110 and work result information (S120). The work result information is information that can quantitatively express the work status of the worker.

For example, in the work line L of the factory where the product P is conveyed on a conveyor as illustrated in FIG. 2, time-series data such as the number of products (that is, a production amount of the product P produced on the work line L) processed on the work line L may be used as the work result information. The number of processed products can be acquired by, for example, capturing, by the image capturing device 3 installed at a work completion position of the work line L, an image of the product P conveyed on the line, and counting the number of products P passing through the work completion position through image recognition.

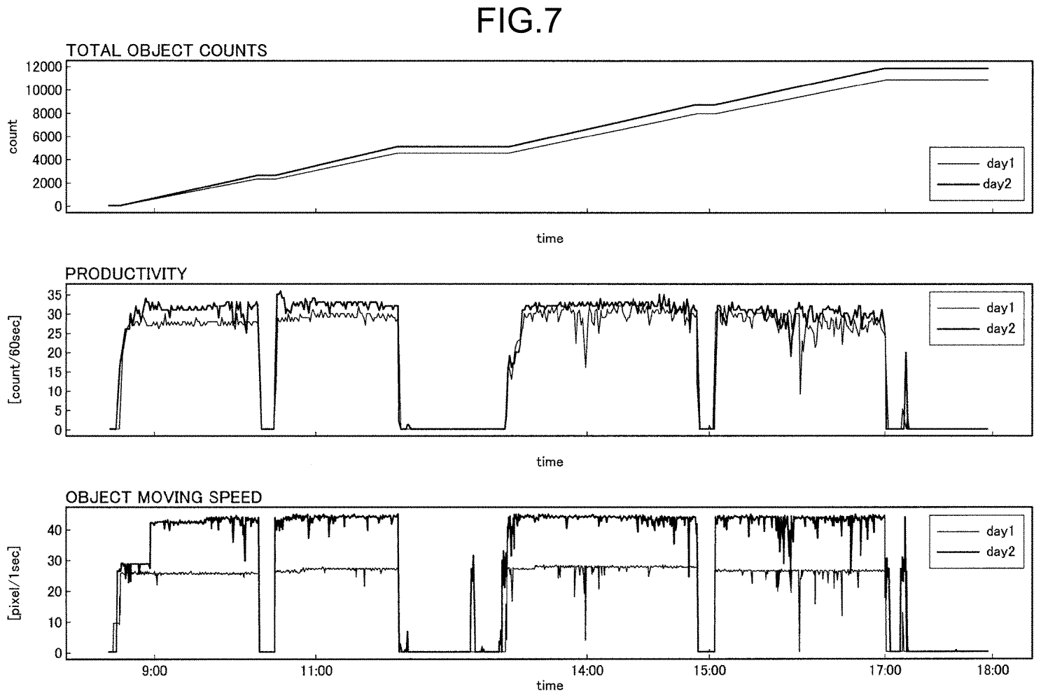

In a case where the production amount on the work line L is acquired with the smallest count granularity, the number of products may be represented one by one in association with a work completion time on the work line L. Alternatively, the count granularity of the products P may be increased to represent the number of products P processed on the work line L per unit time (for example, 1 second, 5 seconds, 30 seconds, and the like). FIG. 7 illustrates an example of how to represent the production amount on the work line L. A horizontal axis of FIG. 7 is a time axis, and a vertical axis represents a value corresponding to the production amount. FIG. 7 illustrates production amounts on the work line per day for two different days (Day 1 and Day 2).

The upper part of FIG. 7 is an example of work result information in a case where the production amount on the work line is represented with the smallest count granularity, in which the production amount is counted for each work completion time for the product P on the work line L. The center of FIG. 7 is an example of work result information indicating a production amount per unit time. Here, the number of products P processed per 60 seconds is shown. Further, the production amount on the work line L may be represented by a moving speed of the product P on the work line L as illustrated on the lower side of FIG. 7. It can be evaluated that the higher the moving speed of the product P, the higher the productivity. The smaller the granularity of the work result information, the more detailed the work status of the worker can be grasped.

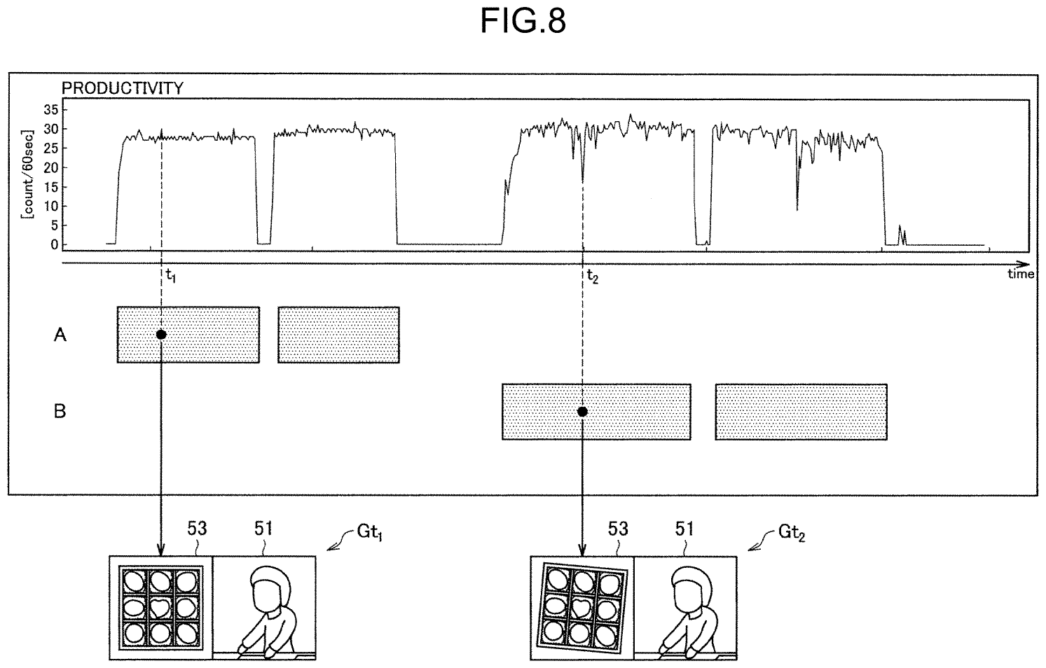

The quantified information generation unit 115 generates quantified information in which a work status of a worker is quantitatively expressed by work result information by associating, based on time information, a work content identified based on position information of the worker with work result information corresponding to the work content. An example of the quantified information is illustrated in FIG. 8. FIG. 8 illustrates a relationship between a production amount per unit time on the work line L in one day and working hours of workers A and B who worked on the work line L. It can be seen from FIG. 8 that, on the work line L, the worker A worked in the morning and the worker B worked in the afternoon. It can be seen that the production amount per unit time on the work line L is almost constant in the morning, but the production amount per unit time on the work line L is uneven in the afternoon. As such, the quantified information makes it possible to quantitatively show a work status of a worker on the work line L in a form of the production amount per unit time.

Furthermore, the quantified information generation unit 115 may generate, as the quantified information, information in which a work content and working hour of a worker identified by the work identification unit 113 and a preset work schedule of the worker are associated with each other on the same time axis. By presenting such quantified information, the user can easily check whether or not the worker works according to the determined schedule.

The quantified information generation unit 115 may record the generated quantified information in the quantified information DB 125, or may perform processing of outputting the quantified information to the output unit 43 to present the quantified information to an operator or the like.

Hereinabove, the work quantification processing of the information processing apparatus 100 in the work evaluation system 1 has been described. In the work quantification processing, a work status of a worker is quantitatively shown by identifying a work content of the worker based on position information of the worker in the work region S and associating a working hour of the worker with work result information corresponding to the work content. As a result, it is possible to quantitatively evaluate a work that it is difficult to accurately acquire the performance of the worker in a unit of second or minute, such as work in a factory.

### (3) Utilization of Quantified Information

The quantified information generated by the information processing apparatus 100 and indicating a work status of a worker can be not only used as information for quantitatively evaluating a work status of the worker, but also utilized for improving the performance of each worker.

### A. Utilization for Job Rotation

As illustrated in FIG. 1, when the plurality of work lines L1 to L3 are arranged in the work region S of the factory, in a case where the worker working on each of the work lines L1 to L3 is fixed, the worker may not correctly understand a work content other than work that he/she is responsible for. In order to improve the productivity in the entire factory, it is desirable that each worker is a multi-skilled worker and correctly understands work contents performed on each of the work lines L1 to L3. Therefore, in a factory having a plurality of work lines, job rotation of workers is performed, and each worker is made to experience work on each work line.

Since the main purpose of the job rotation is to make the worker understand a work content on each work line, a working hour of the worker on each work line serves as a standard when performing the job rotation. For example, the job rotation is performed so that a working hour of each worker on each work line exceeds at least a reference working hour determined for each work line.

Conventionally, it has been difficult to acquire a working hour of a worker in each work line in the work region S in detail, and thus there is a possibility that the job rotation is not properly performed. Therefore, it is possible to quantitatively grasp a work experience of each worker on each work line by using a work content and working hour based on position information of the worker acquired by the work evaluation system 1 according to the present embodiment. By using such quantified information, it becomes possible to perform the job rotation more properly. As a result, each worker can understand work contents of other workers and thus can perform work in consideration of the work of the next process, thereby making it possible to improve the productivity of the entire factory.

### B. Utilization for Work Status Comparison

For example, even for workers who perform the same work on the same work line, such as the workers A and B illustrated in FIG. 8, productivity may differ for each worker. A worker who can work efficiently has the know-how to work efficiently based on experiences. It is desirable that such know-how is accumulated in the factory and shared among workers, but it is not easy to analyze what the know-how is. Further, in some cases, the worker works unconsciously, and thus the worker himself/herself does not recognize what he or she is doing to improve work efficiency.

Therefore, the work evaluation system 1 according to the present embodiment provides a comparison tool that can easily compare work states of the respective workers by using videos. The work state of each worker may be acquired by, for example, a work monitoring camera (not illustrated) installed so as to be able to capture an image of a worker in a work area of a work line. The work monitoring camera continues to acquire a video at least during operation of the work line. The work monitoring camera records, in, for example, the work result information DB 123, the acquired video in association with information for identifying a target work line, and a shooting time.

The video acquired by the work monitoring camera can be associated with work result information such as a production amount, and a working hour of the worker according to the shooting time. Therefore, for example, when the quantified information illustrated in FIG. 8 is displayed on the output unit 43, an arbitrary working hour of the worker may be specified, and a video acquired by the work monitoring camera at that time may be displayed.

In the example of FIG. 8, when a working time t1 is specified, a work monitoring image Gₜ₁ including an image 51 acquired by the work monitoring camera at the working time t1 is displayed on the output unit 43. The work monitoring image Gₜ₁ may be displayed together with an image 53 of a product P manufactured at this time. Further, when a working time t2 is specified, a work monitoring image Gₜ₂ including an image 51 acquired by the work monitoring camera at the working time t2 is displayed on the output unit 43. Here, in a case where a working time at which the worker A works is specified, and a working time at which the worker B works is specified, work states of the workers A and B and products manufactured at these times can be displayed side by side. Furthermore, it is also possible to select a work content and display videos of worker who performed the selected work content side by side, or display past videos of the same person side by side.

As such, a video of a worker who can work efficiently and a video of another worker can be compared using the comparison tool, and the know-how or tips for an efficient work can be obtained from a difference between the work of the workers. In addition, with such a comparison tool, it is possible to easily identify, based on work result information, a time when the work is efficiently performed, a time when the work is not performed efficiently, a time when productivity is high, and a time when productivity is low. Further, in a work line in which a plurality of workers perform work, it is possible to easily identify a video corresponding to a time when a specific worker works among videos acquired by the work monitoring camera. Therefore, with such a comparison tool, it is possible to easily extract a target scene from a video acquired for a long time.

### 3.2. Work Prediction Processing

### (1) Functional Configuration

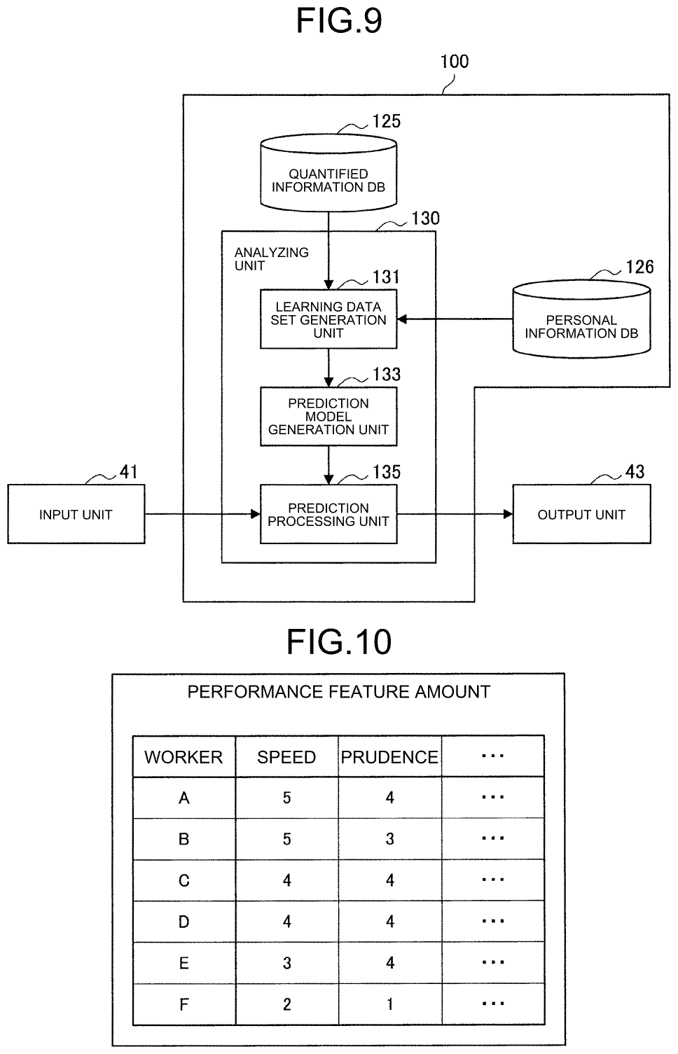

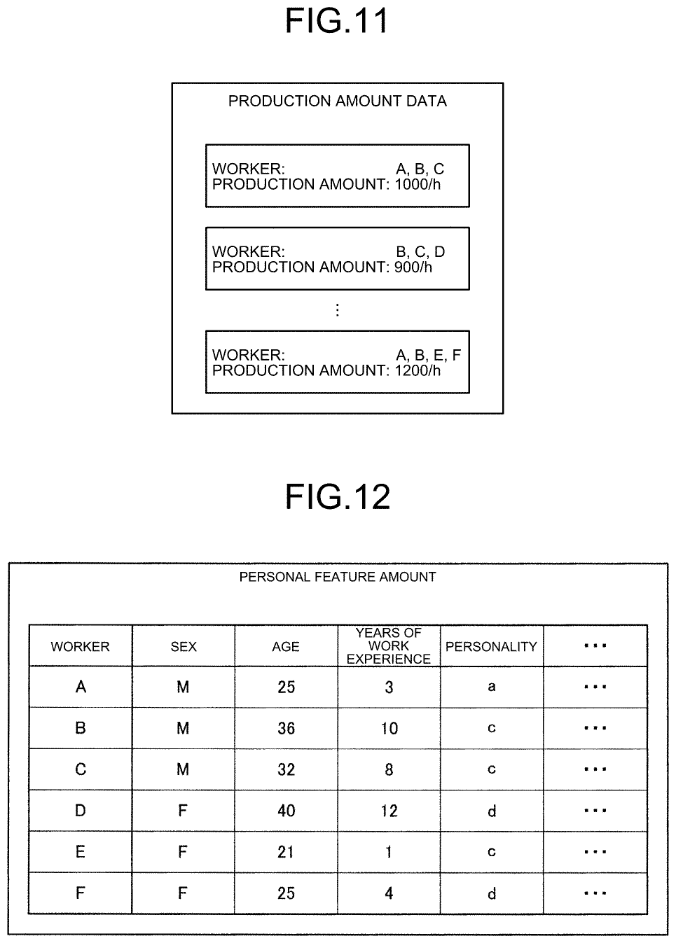

Next, a configuration of functional units of the information processing apparatus 100 that are operated when performing the work prediction processing will be described with reference to FIGS. 9 to 11. FIG. 9 is a functional block diagram illustrating a functional configuration of the information processing apparatus 100 of the work evaluation system 1 according to the present embodiment, and illustrates the functional units that perform the work prediction processing. FIG. 10 is a diagram illustrating an example of performance feature amount data. FIG. 11 is a diagram illustrating an example of production amount data. FIG. 12 is a diagram illustrating an example of personal feature amount data.

As illustrated in FIG. 9, the information processing apparatus 100 includes, as the functional units that perform the work prediction processing, an analyzing unit 130 and databases such as the quantified information DB 125 and a personal information DB 126.

The analyzing unit 130 predicts optimal personnel arrangement in the factory based on quantified information in the past operation. As illustrated in FIG. 9, the analyzing unit 130 includes a learning data set generation unit 131, a prediction model generation unit 133, and a prediction processing unit 135.

The learning data set generation unit 131 generates a data set used as learning data in building a prediction model. The learning data set generation unit 131 uses, as the learning data, at least quantified information acquired by the quantification processing unit 110. Specifically, performance feature amount data of each worker that is obtained as a work status of a worker and production amount data obtained from work result information are used as the learning data.

The performance feature amount data is information in which the performance of each worker is digitized. For example, as illustrated in FIG. 10, values of items representing performance of a worker, such as a work speed, accuracy, prudence, and concentration, are set for each worker. For example, a larger value of an item may indicate that the worker is excellent in the item. The performance feature amount data can be generated by digitizing information (for example, a production amount, a moving speed of a product, or the like) acquired from the quantified information based on a preset conversion condition. In a case of a work speed, for example, the conversion condition is that the work speed is “1” in a case where a production amount per unit time is 10 or less, the work speed is “2” in a case where a production amount per unit time is more than 10 to 15 or less, and the work speed is “3” in a case where a production amount per unit time is more than 15 to 20 or less.

The production amount data is data indicating a relationship between a worker and a production amount on a work line. That is, the production amount data is data indicating how much production amount is achieved by whom and what work on a work line. FIG. 11 is a diagram illustrating an example of the production amount data. For example, as illustrated in FIG. 11, the production amount data shows that a production amount when workers A, B, and C perform work on a work line is 1000/h, and a production amount when workers B, C, and D perform work is 900/h. Note that the production amount data may include not only data in a case where a plurality of workers perform work, but also data in a case where one worker performs work independently.

The performance feature amount data and the production amount data are each acquired for work on the same work line or in the same factory.

Furthermore, as the learning data, personal feature amount data indicating personal information of a worker may be used, in addition to the performance feature amount data and the production amount data. FIG. 12 illustrates an example of the personal feature amount data.

The personal feature amount is, for example, age, sex, years of work experience on the work line, or personality, and is recorded in the personal information DB 126 in advance. The personality may be classified according to, for example, a tendency (for example, classified into a to d), and may be set based on a report of a worker himself, certification by a work manager, a result of a personality diagnostic test, and the like.

The prediction model generation unit 133 uses a learning data set generated by the learning data set generation unit 131 to build a prediction model that infers a production amount to be achieved by a combination of workers, by using machine learning or the like. The prediction model may be built using an existing machine learning method.

The prediction model may output, for example, a production amount on a work line in a case where work is performed by a plurality of workers input through the input unit 41. In such a prediction model, once workers who perform the work are input, a predicted production amount on the work line is output. Specifically, a prediction result indicating that a production amount on the work line is 1100/h when workers A, D, and E perform work is output. With such a prediction model, a change of a combination of workers is performed, and a combination of workers that can achieve the highest production amount is searched for.

Alternatively, the prediction model may predict an optimum combination of workers (that is, an optimum solution) that can maximize a production amount on the work line, among workers included in the learning data set.

The prediction processing unit 135 uses the prediction model built by the prediction model generation unit 133 to predict a production amount on a work line that is to be achieved by a combination of workers. A prediction result is output to the output unit 43 and presented to the user.

### (2) Processing Example

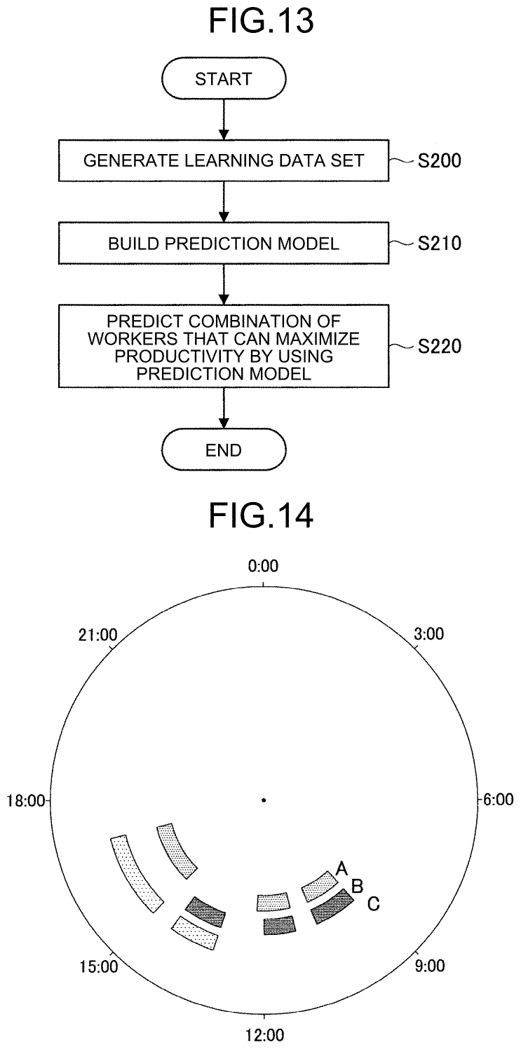

The work prediction processing performed by the information processing apparatus 100 will be described with reference to FIG. 13. FIG. 13 is a flowchart illustrating the work prediction processing performed by the information processing apparatus 100.

First, as illustrated in FIG. 13, the learning data set generation unit 131 generates a data set used as learning data in building a prediction model (S200). The learning data set generation unit 131 uses, as the learning data, at least quantified information acquired by the quantification processing unit 110. Specifically, performance feature amount data of each worker that is obtained as a work status of a worker and production amount data obtained from work result information are used as the learning data. Furthermore, as the learning data, personal feature amount data indicating personal information of a worker may be used, in addition to the performance feature amount data and the production amount data.

Next, the prediction model generation unit 133 uses the learning data set generated by the learning data set generation unit 131 to build a prediction model that infers a production amount to be achieved by a combination of workers, by using machine learning or the like (S210). The prediction model may be built using an existing machine learning method.

Then, the prediction processing unit 135 uses the prediction model built by the prediction model generation unit 133 to predict a production amount on a work line that is to be achieved by a combination of workers (S220). A prediction result is output to the output unit 43 and presented to the user. A prediction result obtained from the prediction model may present, for example, a combination of workers and a predicted production amount. Alternatively, the prediction result may present a combination of workers that can maximize a production amount, among workers who can work on the work line.

Hereinabove, the work prediction processing of the information processing apparatus 100 in the work evaluation system 1 has been described. In the work prediction processing, it is possible to determine personnel arrangement that can increase a production amount by building a prediction model that predicts the performance of workers, based on quantified information acquired by the work evaluation system 1.

As an application example of the work prediction processing, for example, prediction as to which worker needs to improve the performance to improve the overall performance can be considered. In this case, it is possible to perform simulation to check which capability of the worker is to be improved, by changing a value of performance feature amount data of the worker and performing prediction. Specifically, simulation using the prediction model may be performed by changing each of values of the performance feature amount data such as a work speed, accuracy, prudence, and concentration of each worker, thereby predicting a change in productivity. For example, in a case where a result indicating that improving a speed of a certain worker improves the productivity, as compared with improving prudence is obtained, a training plan for improving a work speed of the worker can be created. Job rotation optimization, personnel arrangement automation, and training plan creation can be implemented by using such a prediction model.

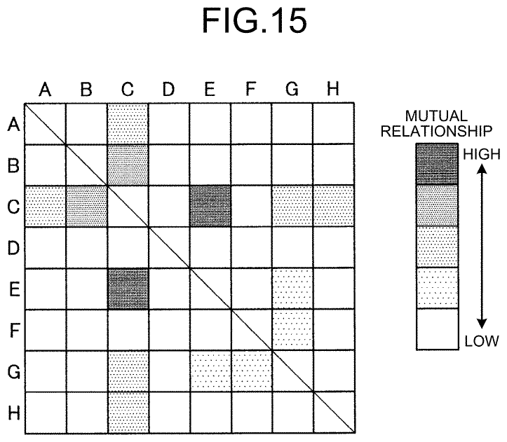

A result of the job rotation optimization may show a working hour of a worker by, for example, setting a time axis of one day in a circumferential direction as illustrated in FIG. 14. Further, a result of the personnel arrangement may show a mutual relationship between workers that improves productivity as illustrated in FIG. 15. In FIG. 15, mutual relationships between workers A to H are shown with light and shade of cells on a matrix. With this, it is possible to expect improvement in productivity by arranging workers in a work line so that workers having a favorable mutual relationship work in the same time zone.

### 3.3. Real-time Processing

The real-time processing performed by work evaluation system 1 can also associate a work content that can be identified based on position information of a worker with a work result in real time. A result of the real-time processing can be used, for example, to check whether or not the worker is correctly performing a determined routine work, or to confirm that the worker can perform the work safely.

### (1) Functional Configuration

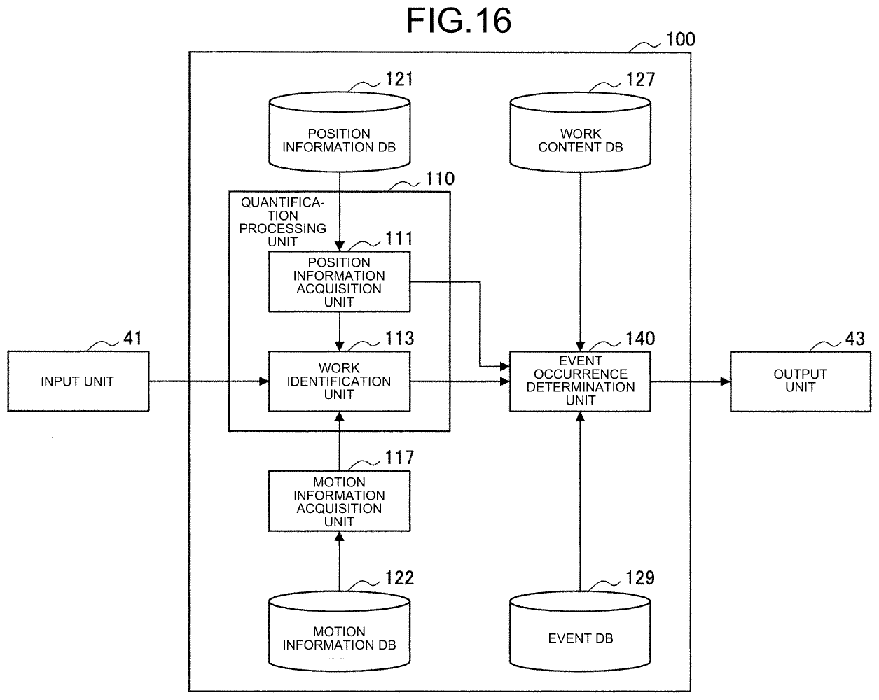

A configuration of functional units of the information processing apparatus 100 that are operated when performing the real-time processing of checking a work status of a worker in real time will be described with reference to FIG. 16. FIG. 16 is a functional block diagram illustrating a functional configuration of the information processing apparatus 100 of the work evaluation system 1 according to the present embodiment, and illustrates functional units that perform the real-time processing.

As illustrated in FIG. 16, the information processing apparatus 100 includes, as the functional units that perform the real-time processing, the quantification processing unit 110, and databases such as the position information DB 121, the motion information DB 122, a work content DB 127, and an event DB 129. Since the quantification processing unit 110 has the same configuration as that illustrated in FIG. 3, a description thereof is omitted here. Note that, although not illustrated in FIG. 16, the quantification processing unit 110 includes the quantified information generation unit 115 as illustrated in FIG. 3.

An event occurrence determination unit 140 determines whether or not an event has occurred based on position information and a work content of a worker identified by the work identification unit 113.

For example, checking performed by a person or routine work tends to be performed with less deliberation as the worker gets used to it. Therefore, the event occurrence determination unit 140 determines whether or not a worker correctly performs work by comparing a work content to be performed by the worker with a current work status (where and what the worker is doing) of the worker, the work content being recorded in the work content DB 127.

In addition, accidents in the factory or the like can occur even with sufficient caution. A situation in which an accident occurs has a certain context. For example, occurrence of an accident is likely to increase when working alone, during cleaning, before operation of a work line, when a new worker joins, or the like. Therefore, the event occurrence determination unit 140 determines whether or not an event is likely to occur by comparing an event occurrence context that represents an event that can occur in the work region S with a current work status (a status in which the worker is working) of the worker, the event being set in the event DB 129.

These determinations are performed based on, for example, the degree of matching between the work content to be performed by the worker or event occurrence context, and the current work status of the worker. In a case of determining whether or not a worker correctly performs work, the worker or manager is notified of an abnormal state when the degree of matching between a work content to be performed by the worker and a current work status of the worker is less than a predetermined value. Further, in a case of determining a possibility of event occurrence, it is determined that the possibility of event occurrence is high when the degree of matching between an event occurrence context and a current work status of the worker exceeds a predetermined threshold value. When it is determined that the possibility of event occurrence is high, the event occurrence determination unit 140 performs processing such as notifying the worker or manager or stopping the operation of the work line.

### (2) Processing Example

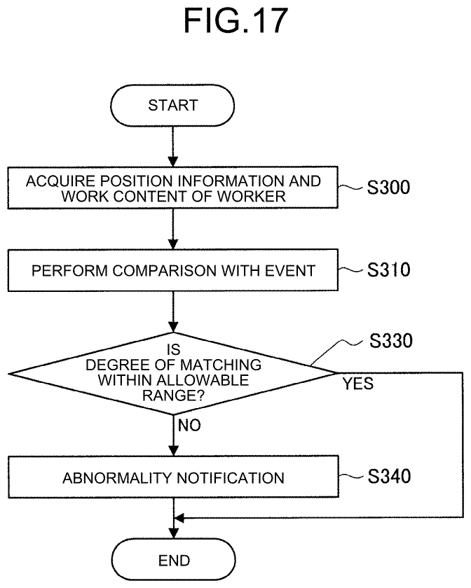

The real-time processing performed by the information processing apparatus 100 will be described with reference to FIG. 17. FIG. 17 is a flowchart illustrating the real-time processing performed by the information processing apparatus 100.

First, the event occurrence determination unit 140 acquires position information and a work content of a worker identified by the work identification unit 113 of the quantification processing unit 110 (S300). The acquisition of these pieces of information may be performed at a predetermined timing, for example, at a timing at which the position information is acquired or once every several minutes.

Next, the event occurrence determination unit 140 compares the position information and work content of the worker with an event (S310). The event includes a work content recorded in the work content DB 127 to be performed by the worker, an event occurrence context set in the event DB 129, and the like. The event occurrence determination unit 140 calculates the degree of matching between the position information and work content of the worker and these events.

Then, the event occurrence determination unit 140 determines whether or not the calculated degree of matching is within an allowable range (S330). The allowable range can be set for each comparison target. For example, in a case of determining whether or not the worker correctly performs work, the degree of matching is within the allowable range when the degree of matching is equal to or higher than a predetermined value. Further, in a case of determining a possibility of event occurrence, it is determined that the degree of matching is within the allowable range when the degree of matching between the event occurrence context and a current work status of the worker is equal to or less than a predetermined threshold value.

In a case where a result of the determination in Step S330 indicates that the degree of matching is within the allowable range, the processing of FIG. 17 ends, and waits until the next timing for performing Step S300. On the other hand, in a case where the degree of matching is out of the allowable range, the event occurrence determination unit 140 performs abnormality notification processing such as notifying the worker or manager through the output unit 43 or the like, or stopping the operation of the work line (S340).

Hereinabove, the real-time processing of the information processing apparatus 100 in the work evaluation system 1 has been described. In the real-time processing, the possibility of event occurrence in the work region S is determined based on the position information and the work content of the worker that are acquired by the work evaluation system 1. As a result, it is possible to prevent accidents and detect abnormalities in a work status of a worker.

In the above description, a work content of a worker is specified based on position information of the worker, but the present disclosure is not limited to this example. For example, a work content of a worker may be specified based on motion information of a body part of the worker that is acquired by the motion information acquisition unit 117 from the motion information DB 122.

In addition, a rule of determination processing performed as the real-time processing may be appropriately set with items such as a “target (who)”, a “position (where)”, an “action (what)”, and a “time (when)” according to a content to be detected. For example, it is possible to set a rule such that abnormality notification is made in a case where “a product inspection worker (who) leaves (what) a product inspection area (where) during operation of the line (when)”. As for the “target (who)”, an individual worker may be set or a job position may be set. As for the “action (what)”, various actions can be set, and a more specific action such as “leaving for 5 minutes” may be set.

### 4. Hardware Configuration

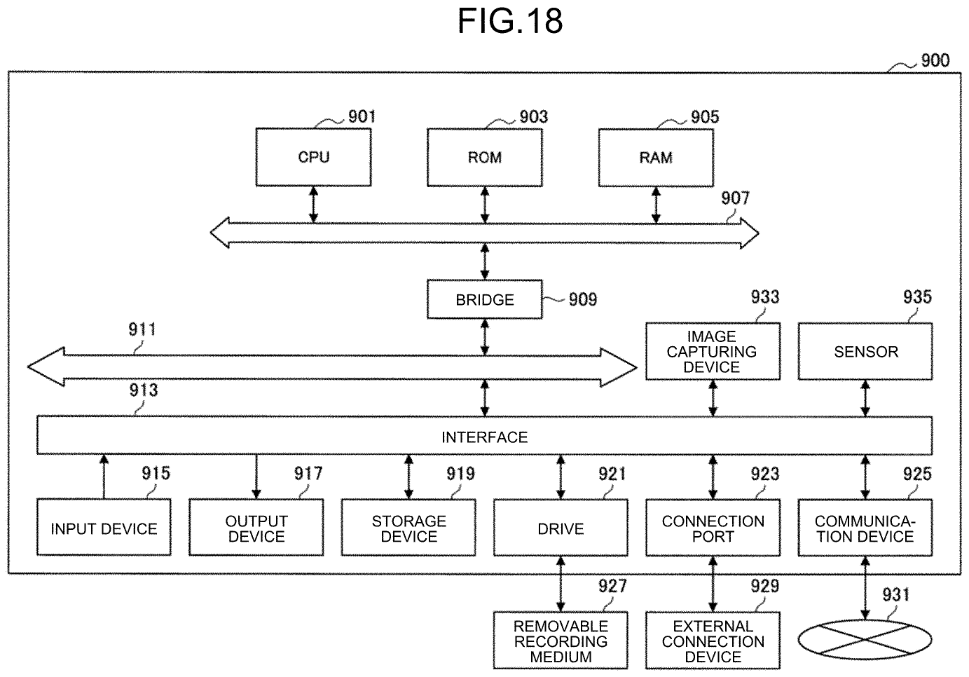

Next, with reference to FIG. 18, a hardware configuration of an information processing apparatus according to an embodiment of the present disclosure will be described. FIG. 18 is a block diagram illustrating a hardware configuration example of the information processing apparatus according to the embodiment of the present disclosure. An information processing apparatus 900 illustrated in FIG. 18 can implement the information processing apparatus 100 in the above-described embodiment, for example.

The information processing apparatus 900 includes a central processing unit (CPU) 901, a read only memory (ROM) 903, and a random access memory (RAM) 905. Further, the information processing apparatus 900 may include a host bus 907, a bridge 909, an external bus 911, an interface 913, an input device 915, an output device 917, a storage device 919, a drive 921, a connection port 923, and a communication device 925. Furthermore, the information processing apparatus 900 may include an image capturing device 933 and a sensor 935, if necessary. The information processing apparatus 900 may include a processing circuit such as a digital signal processor (DSP), an application specific integrated circuit (ASIC), or a field-programmable gate array (FPGA), instead of or in addition to the CPU 901.

The CPU 901 functions as an arithmetic operation processing unit and a control unit, and controls an overall operation performed in the information processing apparatus 900 or a part thereof according to various programs recorded in the ROM 903, the RAM 905, the storage device 919, or a removable recording medium 927. The ROM 903 stores a program used by the CPU 901, an arithmetic operation parameter, or the like. The RAM 905 primarily stores a program used in the execution of the CPU 901, a parameter that appropriately varies in the execution, or the like. The CPU 901, the ROM 903, and the RAM 905 are mutually connected by the host bus 907 implemented by an internal bus such as a CPU bus. Furthermore, the host bus 907 is connected to the external bus 911 such as a peripheral component interconnect/interface (PCI) bus via the bridge 909.

The input device 915 is a device operated by a user, such as a mouse, a keyboard, a touch panel, a button, a switch, or a lever. The input device 915 may be, for example, a remote control device using infrared rays or other radio waves, or may be an external connection device 929 such as a mobile phone corresponding to the operation of the information processing apparatus 900. The input device 915 includes an input control circuit that generates an input signal based on information input by the user and outputs the input signal to the CPU 901. By operating this input device 915, the user inputs various data to the information processing apparatus 900 or gives an instruction for a processing operation.

The output device 917 is implemented by a device capable of notifying the user of the acquired information by using senses such as sight, hearing, and touch. The output device 917 can be, for example, a display device such as a liquid crystal display (LCD) or an organic electro-luminescence (EL) display, an audio output device such as a speaker or headphones, a vibrator, or the like. The output device 917 outputs a result obtained by the processing performed by the information processing apparatus 900 as a text, a video such as an image, a sound such as voice, vibration, or the like.

The storage device 919 is a data storage device configured as an example of a storage unit of the information processing apparatus 900. The storage device 919 is implemented by, for example, a magnetic storage device such as a hard disk drive (HDD), a semiconductor storage device, an optical storage device, a magneto-optical storage device, or the like. The storage device 919 stores, for example, programs executed by the CPU 901 or various data, various data acquired from the outside, and the like.

The drive 921 is a reader/writer for the removable recording medium 927 such as a magnetic disk, an optical disk, a magneto-optical disk, or a semiconductor memory, and is embedded in or externally attached to the information processing apparatus 900. The drive 921 reads information recorded in the mounted removable recording medium 927 and outputs the read information to the RAM 905. Further, the drive 921 also writes a record in the mounted removable recording medium 927.

The connection port 923 is a port for connecting a device to the information processing apparatus 900. The connection port 923 can be, for example, a universal serial bus (USB) port, an IEEE 1394 port, a small computer system interface (SCSI) port, or the like. Further, the connection port 923 may be an RS-232C port, an optical audio terminal, a high-definition multimedia interface (HDMI) (registered trademark) port, or the like. By connecting the external connection device 929 to the connection port 923, various data can be exchanged between the information processing apparatus 900 and the external connection device 929.

The communication device 925 is, for example, a communication interface implemented by a communication device and the like for connection to a communication network 931. The communication device 925 can be, for example, a local area network (LAN), Bluetooth (registered trademark), Wi-Fi, wireless USB (WUSB) communication card, or the like. The communication device 925 may be a router for optical communication, a router for asymmetric digital subscriber line (ADSL), a modem for various types of communication, or the like. The communication device 925 transmits and receives a signal or the like to and from, for example, the Internet and other communication devices using a predetermined protocol such as TCP/IP. Further, the communication network 931 connected to the communication device 925 is a network connected in a wired or wireless manner, and can include, for example, the Internet, home-based LAN, infrared communication, radio wave communication, satellite communication, or the like.

The image capturing device 933 is a device that captures an image of an actual space by using an image capturing element such as a complementary metal oxide semiconductor (CMOS) or a charge coupled device (CCD), and various members such as a lens for controlling formation of a subject image on the image capturing element, and generates a captured image. The image capturing device 933 may capture a still image, or may capture a moving image.

Examples of the sensor 935 include various sensors such as an acceleration sensor, an angular velocity sensor, a geomagnetic sensor, an illuminance sensor, a temperature sensor, an atmospheric pressure sensor, and a sound sensor (microphone). The sensor 935 acquires information regarding a state of the information processing apparatus 900 itself, such as an orientation of a housing of the information processing apparatus 900, or information regarding a surrounding environment of the information processing apparatus 900, such as the brightness or noise around the information processing apparatus 900. Further, the sensor 935 may include a global positioning system (GPS) receiver that receives a GPS signal and measures the latitude, longitude, and altitude of the device.

Hereinabove, an example of the hardware configuration of the information processing apparatus 900 has been described. Each component described above may be implemented by using a general-purpose member, or may be implemented by hardware specialized for the function of each component. Such components can be appropriately changed according to a technical level at the time of implementation.

The preferred embodiments of the present disclosure have been described above in detail with reference to the accompanying drawings, but the technical scope of the present disclosure is not limited to such examples. It is obvious that a person having ordinary knowledge in the technical field of the present disclosure can derive various changes or modifications within the scope of the technical idea described in the claims, and it is naturally understood that the changes or modifications also fall within the technical scope of the present disclosure.

For example, in the above-described embodiment, the worker is assumed to be a human, but the present technology is not limited to this example. For example, the worker can include a factory machine. A machine can also be considered as a worker in a wide sense, and it is also possible to evaluate a work status by using the work evaluation system of the present technology based on data indicating an operating status of the machine.

Further, the effects described in the present specification are merely explanatory or illustrative, and are not limitative. That is, the technology according to the present disclosure may have other effects that are apparent to those skilled in the art from the description of the present specification, in addition to or instead of the above-described effects.

Note that the following components also belong to the technical scope of the present disclosure.

(1)

An information processing apparatus comprising:

a work identification unit that identifies a work content and a working hour of a worker based on time-series data of position information of the worker at least in a work region; and

a quantified information generation unit that generates quantified information quantitatively expressing a work status of the worker, based on time-series data of a production amount on a work line corresponding to the identified work content, and the working hour of the worker.

(2)

The information processing apparatus according to (1), wherein the work identification unit identifies the work content and the working hour of the worker based further on motion information of a body part of the worker.

(3)

The information processing apparatus according to (1) or (2), wherein the work identification unit identifies the work content of the worker based on a movement trajectory of the worker that is identified based on the time-series data of the position information of the worker, and information on object arrangement in the work region including the work line.

(4)

The information processing apparatus according to (3), wherein the information on object arrangement in the work region is specified by a user.

(5)

The information processing apparatus according to any one of (1) to (4), wherein the quantified information generation unit generates, as the quantified information, information in which the production amount on the work line and the working hour of the worker on the work line are associated with each other on the same time axis.

(6)

The information processing apparatus according to any one of (1) to (5), wherein the quantified information generation unit generates, as the quantified information, information in which time-series data of an image of a work product on the work line and the working hour of the worker on the work line are associated with each other on the same time axis.

(7)

The information processing apparatus according to any one of (1) to (6), wherein the quantified information generation unit generates, as the quantified information, information in which the work content and the working hour of the worker that are identified by the work identification unit and a preset work schedule of the worker are associated with each other on the same time axis.

(8)

The information processing apparatus according to any one of (1) to (7), further comprising: an event occurrence determination unit that determines whether or not an event has occurred by comparing an event occurrence context in the work region with the work content and the working hour of the worker.

(9)

The information processing apparatus according to (8), wherein the event occurrence determination unit outputs a determination result via an output device in a case where it is determined that an event has occurred.

(10)

The information processing apparatus according to any one of (1) to (9), further comprising a prediction model generation unit that generates a prediction model that predicts a relationship between the worker and a production amount based on production amount data generated by the quantified information generation unit and indicating the production amount in work performed by a plurality of the workers, and work feature amount data indicating a work capability of each of the workers.

(11)

The information processing apparatus according to (10), wherein the prediction model generation unit generates the prediction model by further using personal feature amount data indicating personal information of each of the workers.

(12)

The information processing apparatus according to (10) or (11), further comprising a prediction processing unit that predicts, by using the prediction model, a production amount on the work line that is to be achieved by a combination of the workers.

(13)

An information processing method comprising:

identifying a work content and a working hour of a worker based on time-series data of position information of the worker at least in a work region; and

generating quantified information quantitatively expressing a work status of the worker, based on time-series data of a production amount on a work line corresponding to the identified work content, and the working hour of the worker.

(14)

A work evaluation system comprising:

a position information acquisition device that acquires position information of a worker in at least a work region as time-series data;

a production amount acquisition device that acquires a production amount on a work line in the work region as time-series data; and

an information processing apparatus including a work identification unit that identifies a work content and a working hour of the worker based on the time-series data of the position information of the worker in the work region, and

a quantified information generation unit that generates quantified information quantitatively expressing a work status of the worker, based on the time-series data of the production amount on the work line corresponding to the identified work content, and the working hour of the worker.

### REFERENCE SIGNS LIST

1 WORK EVALUATION SYSTEM
1a to 1d ANCHOR
2a, 2b TAG
3 IMAGE CAPTURING DEVICE
4a, 4b ROUTER
10 NETWORK
20 CLOUD
40 INTERFACE TERMINAL
41 INPUT UNIT
43 OUTPUT UNIT
100 INFORMATION PROCESSING APPARATUS
110 QUANTIFICATION PROCESSING UNIT
111 POSITION INFORMATION ACQUISITION UNIT
113 WORK IDENTIFICATION UNIT
115 QUANTIFIED INFORMATION GENERATION UNIT
117 MOTION INFORMATION ACQUISITION UNIT
121 POSITION INFORMATION DB
122 MOTION INFORMATION DB
124 USER SETTING REGION DB
123 WORK RESULT INFORMATION DB
125 QUANTIFIED INFORMATION DB
126 PERSONAL INFORMATION DB
127 WORK CONTENT DB
129 EVENT DB
130 ANALYZING UNIT
131 LEARNING DATA SET GENERATION UNIT
133 PREDICTION MODEL GENERATION UNIT
135 PREDICTION PROCESSING UNIT
140 EVENT OCCURRENCE DETERMINATION UNIT

1. An information processing apparatus comprising:
a work identification unit that identifies a work content and a working hour of a worker based on time-series data of position information of the worker at least in a work region; and
a quantified information generation unit that generates quantified information quantitatively expressing a work status of the worker, based on time-series data of a production amount on a work line corresponding to the identified work content, and the working hour of the worker.

2. The information processing apparatus according to claim 1, wherein the work identification unit identifies the work content and the working hour of the worker based further on motion information of a body part of the worker.

3. The information processing apparatus according to claim 1, wherein the work identification unit identifies the work content of the worker based on a movement trajectory of the worker that is identified based on the time-series data of the position information of the worker, and information on object arrangement in the work region including the work line.

4. The information processing apparatus according to claim 3, wherein the information on object arrangement in the work region is specified by a user.

5. The information processing apparatus according to claim 1, wherein the quantified information generation unit generates, as the quantified information, information in which the production amount on the work line and the working hour of the worker on the work line are associated with each other on the same time axis.

6. The information processing apparatus according to claim 1, wherein the quantified information generation unit generates, as the quantified information, information in which time-series data of an image of a work product on the work line and the working hour of the worker on the work line are associated with each other on the same time axis.

7. The information processing apparatus according to claim 1, wherein the quantified information generation unit generates, as the quantified information, information in which the work content and the working hour of the worker that are identified by the work identification unit and a preset work schedule of the worker are associated with each other on the same time axis.

8. The information processing apparatus according to claim 1, further comprising: an event occurrence determination unit that determines whether or not an event has occurred by comparing an event occurrence context in the work region with the work content and the working hour of the worker.

9. The information processing apparatus according to claim 8, wherein the event occurrence determination unit outputs a determination result via an output device in a case where it is determined that an event has occurred.

10. The information processing apparatus according to claim 1, further comprising a prediction model generation unit that generates a prediction model that predicts a relationship between the worker and a production amount based on production amount data generated by the quantified information generation unit and indicating the production amount in work performed by a plurality of the workers, and work feature amount data indicating a work capability of each of the workers.

11. The information processing apparatus according to claim 10, wherein the prediction model generation unit generates the prediction model by further using personal feature amount data indicating personal information of each of the workers.

12. The information processing apparatus according to claim 10, further comprising a prediction processing unit that predicts, by using the prediction model, a production amount on the work line that is to be achieved by a combination of the workers.

13. An information processing method comprising:
identifying a work content and a working hour of a worker based on time-series data of position information of the worker at least in a work region; and
generating quantified information quantitatively expressing a work status of the worker, based on time-series data of a production amount on a work line corresponding to the identified work content, and the working hour of the worker.

14. A work evaluation system comprising:
a position information acquisition device that acquires position information of a worker in at least a work region as time-series data;
a production amount acquisition device that acquires a production amount on a work line in the work region as time-series data; and
an information processing apparatus including a work identification unit that identifies a work content and a working hour of the worker based on the time-series data of the position information of the worker in the work region, and
a quantified information generation unit that generates quantified information quantitatively expressing a work status of the worker, based on the time-series data of the production amount on the work line corresponding to the identified work content, and the working hour of the worker.
